(19) United States
(12) Patent Application Publication
(10) Pub. No.: US 2015/0113023 A1
(43) Pub. Date: Apr. 23, 2015

(54) WEB APPLICATION FOR DEBATE MAPS

(71) Applicant: Thoughtgraph Ltd., Somerset (GB)

(72) Inventors: Peter Jeremy BALDWIN, Blackheath (AU); David Alexander PRICE, Somerset (GB)

(21) Appl. No.: 14/565,431

(22) Filed: Dec. 10, 2014

Related U.S. Application Data
(63) Continuation of application No. 14/070,535, filed on Nov. 3, 2013, now abandoned.
Application No. 14/070,535 is a continuation of application No. 13/754,931, filed on Jan. 31, 2013, now abandoned.
Application No. 13/754,931 is a continuation of application No. 13/175,858, filed on Jul. 3, 2011, now abandoned.
Application No. 13/175,858 is a continuation of application No. 12/446,436, filed on Apr. 20, 2009, now abandoned.

(30) Foreign Application Priority Data
Oct. 20, 2006 (AU) 2006905855
Mar. 29, 2007 (AU) 2007901931
Mar. 30, 2007 (AU) 2007901669
Jul. 10, 2007 (AU) 2007903745

(51) Int. Cl. G06F 17/30; G06F 17/22

(52) U.S. Cl. CPC G06F 17/30327; G06F 17/30289; G06F 17/2247
USPC 707/797; 707/803

(57) ABSTRACT

A fully web-enabled software system for building, editing, evaluating, rendering, navigating and storing an integrated repository of debate in which schematic representations of individual debates are bound together to form an over-arching repository of debate by a multiplicity of user-specified semantic cross-relationships that allow the emergence of clusters of related debates. The system is comprised of:
A Application software that allows system users to build and edit debate maps made up of discrete elements representing entities such as issues or questions, claims, positions, and simple and compound arguments, scenarios and debate protagonists in accordance with a set of constraints herein termed a map grammar that ensure that such maps are constructed in accordance with sound argumentation principles, and in which the set of all such maps are stored in a single, unified data structure.
B Application software that enables users of the system to create an additional layer of semantic cross-relationships between individual debate elements, or nodes, where such elements may be in the same debate map, or in different debate maps, thereby making possible the representation of relationships between debates as well as relationships within elements of single debate maps.

The invention disclosed here is a system and method for building, editing, evaluating and rendering schematic representations, herein termed debate maps, of complex debates in public policy and other spheres, and for modeling the inter-relationships between such debate maps. The invention enables users to move beyond conceptualizing debates in isolation from one another and elucidates the complex relationships between real-world debates, enabling the user to navigate through a debate space characterized by clusters of related debates. At all times, users work with a tractably sized set of map data that allows them to focus on a comprehensible subset of what may be a very large debates.

### BACKGROUND

In recent times a number of software tools have been developed to facilitate the modeling and visualization of arguments and debates. Typically such tools model arguments or debates as separate, discrete entities. This is a reasonable approach for relatively simple arguments.

However, real world debates tend to be highly enthymematic in nature—claims made in support or opposition to conclusions are persuasive, or not, because of a range of background beliefs, assumptions and dispositions held by their audiences. Normally, it is not practical to lay these out explicitly in the context of an individual argument or debate map. Furthermore, these assumptions are themselves often highly debatable. To properly understand such a debate, users need a method to expose such influences, to readily bring them to the surface, and to see them in their own debate contexts. The present disclosure describes an invention that addresses this complexity and makes it comprehensible to the user.

The invention disclosed in PCT/AU2005/000483 described a software tool for building individual argument or debate maps in accordance with one of a plurality of map grammars. Map grammars consist of vocabularies of discrete node or, synonymously, element types, with each type providing multiple expressions of content and each having a semantic relationship to its parent in a tree-hierarchy. This disclosure extends this concept by enabling elements throughout an entire repository of maps to be connected using semantic cross-relationships that are separate from the individual map tree-hierarchies, and are not constrained by the tree structure. As with the map grammars, each cross-relationship must of one of an allowed set of types, each having a defined semantic significance, and must conform to a set of rules that govern the types of elements that may be linked by each cross-relation type.

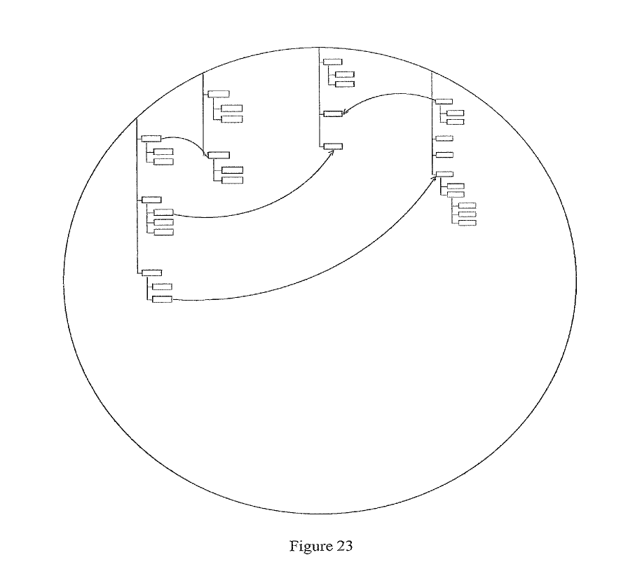

With these features, it is possible to build large semantically-linked debate repositories, which users may navigate either on the plane—within a particular two-dimensional tree-hierarchy—or depth-wise (following trails of semantic cross-relationships), and zoom onto particular elements in such a way as to show the focus element together with other logically related elements to provide a variety of contextual views. Furthermore, the ability to define a plurality of cross-relation types gives navigation and contextual viewing a multi-dimensional quality, with users able to follow different semantic trails depending on their needs or interests. FIG. 23 is a schematic representation of a debate repository consisting of multiple, inter-connected debate maps.

### NOTE ON NOMENCLATURE

This patent application references Australian Provisional Patent Applications 2006905855, 2007901931, 2007901669 and 2007903745 from which this application claims priority. The specifications and drawings of these provisional patent applications are incorporated herein by cross reference. There are some changes in nomenclature between the present application and the provisional specifications, as set out in the following table. Matching terms should be regarded as synonymous.

| AP 2006905855 | This PCT | Description |
|---|---|---|
| Node | Element | Discrete semantic part, or element, of a debate or |
| | | argument map or graph |
| Zoom view | Contextual | A view of a logically defined portion of a debate |
| | view | map or graph that forms part of the context of |
| | | related elements of a particular element, or node. |
| | | In this document, contextual views may be of |
| | | two types: |

| | |
|---|---|
| 1. | Planar views show an element in its |
| | context confined to a specific debate |
| | map. |
| 2. | Depth-wise views show a planar view in |
| | conjunction with a representation of |
| | elements that are related in ways other |
| | than the parent-child relationship of the |
| | basic tree structure. Such relationships |
| | are termed cross-relationships in this |
| | document. |

| | | |
|---|---|---|
| Cross-link | Cross- | Many-to-many relationships between elements |
| | relationship | within a debate map or between different debate |
| | | maps. |
| Guide column | Channel | Visible columns used for navigation around |
| | | contextual views. Guide columns are of two |
| | | types: |

| | |
|---|---|
| 1. | Vertical - used to depict relationships |
| | flowing upward in a planar view. |
| 2. | Horizontal - used to depict cross- |
| | relationships flowing into a specific |
| | element in depth-wise views. |

Notes
The term “comprising” (and grammatical variations thereof) is used in this specification in the inclusive sense of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

### BRIEF DESCRIPTION OF THE INVENTION

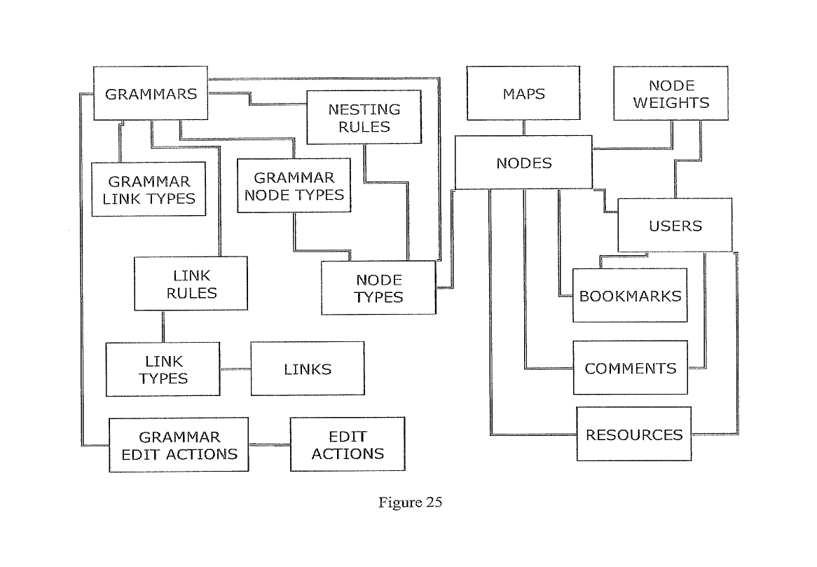

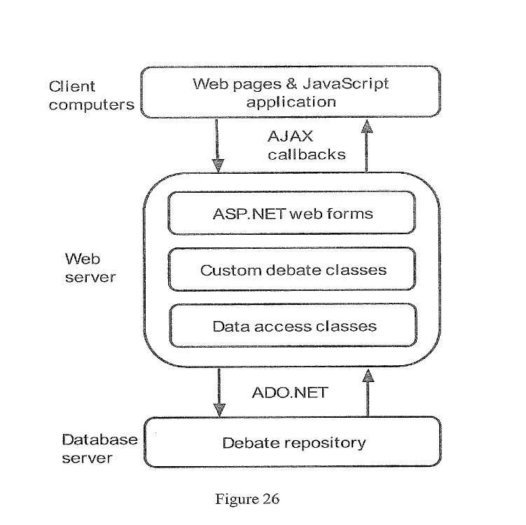

In a preferred form the invention is implemented as a multi-tiered web software application (FIG. 26). In the embodiment described here, it consists of three physical layers, and five logical layers. The layers are:
1. A relational database that stores debate information, including discrete elements of debate structures and relationships between them, information about rules constraining the permitted kinds of relations between such elements, information about users of the application and their roles and permissions, and other information. In one embodiment, such database is managed and served by a relational database application such as Microsoft SQL Server. Such database includes specially defined programmatic procedures and functions, and such relationships and constraints as are needed to support application functionality. FIG. 25 provides a schematic diagram of a possible relational database for this embodiment.
2. Application code that runs on a web server employing a suitable software framework, such as Microsoft ASP.NET framework. The server code consists of three logical sub-layers, which may be executed on a single server, or may be divided between a multiplicity of servers, as follows:
   a. Application code that supports direct interactions with the client layer, as described below.
   b. A library of custom classes representing the various entities used in the application such as debate maps, elements—also called nodes—in debate maps, users of the applications, permissions and roles.
   c. A library of classes that support interactions between the classes defined in a. and b. and the relational database.
3. A client layer consisting of web pages rendered to the end user computers, consisting of dynamically generated (X)HTML and scripts that provide extensive application functionality that executes on the client computer.

The present invention builds on that disclosed in PCT/AU2005/000483, improving and extending the earlier invention in the following respects:
1. Providing ready access to a plurality of different logically defined views of debate information related to a specific element, or node, in the overall debate structure.
2. Improved methods of selecting, filtering and evaluating debate information.
3. Allowing for the presentation of multiple articulations of particular elements in the debate structure.
4. Enabling the representation within a debate map of a multiplicity of real-world protagonists in the debate being modeled, and their contributions to the debate.
5. Allowing the inclusion of a multiplicity of different kinds of semantically significant cross-relationships between elements both within and between debate maps in addition to the debate tree format as described in PCT/AU2005/000483.
6. Supporting the use of cross-relationships described in point 4 to depict such relationships as the grounding of an argument by a broad general principle, which may be debated in a separate map, or any other relationship deemed relevant or useful for debate modeling.
7. Allowing the modeling of debates in which positions taken by debate protagonists may consist of a number of component parts.
8. Supporting the representation of debates that defy characterization in terms of being pro or con some position, and in which a multiplicity of partly over-lapping positions are in contention.
9. Making possible the emergence of clusters of related debates.
10. A greatly improved implementation that takes advantage of recently developed web technologies, such as Asynchronous JavaScript and XML (AJAX).
11. A new method of editing debate maps which takes advantage of web technologies mentioned in point 9 above

Accordingly, in one broad form of the invention, there is provided a fully web-enabled software system for building, editing, evaluating, rendering, navigating and storing an integrated repository of debate in which schematic representations of individual debates are bound together to form an over-arching repository of debate by a multiplicity of user-specified semantic cross-relationships that allow the emergence of clusters of related debates. The system is comprised of:

A Application software that allows system users to build and edit debate maps made up of discrete elements representing entities such as issues or questions, claims, positions, and simple and compound arguments, scenarios and debate protagonists in accordance with a set of constraints herein termed a map grammar that ensure that such maps are constructed in accordance with sound argumentation principles, and in which the set of all such maps are stored in a single, unified data structure.

B Application software that enables users of the system to create an additional layer of semantic cross-relationships between individual debate elements, or nodes, where such elements may be in the same debate map, or in different debate maps, thereby making possible the representation of relationships between debates as well as relationships within elements of single debate maps.

In yet a further broad form of the invention there is provided a fully web-enabled method for building, editing, evaluating, rendering, navigating and storing an integrated repository of debate in which schematic representations of individual debates are bound together to form an over-arching repository of debate by a multiplicity of user-specified semantic cross-relationships that allow the emergence of clusters of related debates comprising the steps of:

A Building and editing debate maps made up of discrete elements representing entities such as issues or questions, claims, positions, and simple and compound arguments, scenarios and debate protagonists in accordance with a set of constraints herein termed a map grammar that ensure that such maps are constructed in accordance with sound argumentation principles, and in which the set of all such maps are stored in a single, unified data structure.

B Creating an additional layer of semantic cross-relationships between individual debate elements, or nodes, where such elements may be in the same debate map, or in different debate maps, thereby making possible the representation of relationships between debates as well as relationships within elements of single debate maps.

Preferably each cross-relationship must be one of an allowed set of cross-relationship types in a set stipulated for the particular map, each with a defined semantic significance.

Preferably the formation of cross-relationships is constrained by a set of rules reflecting sound argumentation principles, herein termed a link grammar.

Preferably the user may view an individual element in a particular map together with a group of other elements each defined by different logically defined contexts within the debate map. Such logically defined contexts are herein termed planar views.

Preferably a detailed view of the individual element, including its heading, concise expression and long expression, metadata about the element, together with different articulations of the element by real-world debate participants and any free-form comments on it, is presented to the user.

Preferably the element is viewed together its parent and immediate children in the debate map tree hierarchy.

Preferably the element viewed together with its parent and grandparent, and its children and grandchildren in the debate map tree-hierarchy.

Preferably the element is viewed together with its complete subtree in the debate map tree hierarchy.

Preferably the element is viewed together with its complete ancestral path, up to and including the root of the debate tree hierarchy.

Preferably any of the planar views may be combined with the display of cross-related elements in the same or other debate maps to provide multi-dimensional views, herein termed depth-wise views, that show both how an element is related to other elements in an individual debate map as well as with elements that may be cross-related in other ways and which may be in other maps and arbitrarily distant in the overall debate database.

Preferably the cross-relationships include a relationship of equivalence indicating that two elements are substantively semantically equivalent, even if expressed in different words and occur in different contexts, or in different maps.

Preferably the cross-relationships include a relationship of variation indicating that an element is a variation of another.

Preferably the cross-relationships include a relationship of grounding indicating that an element expresses a general principle that grounds, or warrants, another element.

Preferably the cross-relationships include a relationship of advocacy that relates an element that represents a protagonist in a debate with a position or argument advocated by that protagonist.

Preferably the cross-relationships include a relationship of relevance indicating that one element is relevant to another.

Preferably the display of related elements in either a planar or depth-wise view may be ordered to reflect user evaluations of the significance of the elements displayed, or by other metrics including the size of the subtree attached to an element.

Preferably users of the system may build a id edit individual maps, and create and evaluate cross-relations within and between maps.

Preferably any of the planar or depth-wise views include, for each element, an indication of the presence of any cross-related elements, whether incoming to the element or outgoing from the element, together with a means to load and display such elements into the view by clicking an icon or link or other method.

Preferably the user, having displayed a depth-wise view focused on a particular element that includes cross-related elements as well as proximate elements in the debate tree, may navigate to any displayed cross-related element by loading a map view focused on said element in its own native map context, and from there in turn navigate to other elements related to any element in the newly displayed view, and by repeating these steps follow a path through the debate repository.

Preferably the user is able to navigate back and forth along the said path.

Preferably programming code ensures that as the user navigates through a large map or repository of maps, a limited set of data is retrieved at any time and the user has means to readily retrieve and view any un-retrieved data, thereby making it practical to work with large maps and map repositories.

Preferably application programming maintains metrics of the number and strength of cross-relationships that cross map boundaries and applies such measures to generate clusters of related maps.

Preferably the user is able to filter out parts of a debate map deemed to be of lesser significance.

Preferably the filtering method further includes the step of filtering out elements that fall below a specified level of average significance as assessed by users of the system.

Preferably the filtering method includes a method of filtering maps by excluding certain element types, such as subsidiary issues raised in the context of a map, or component parts of positions taken in debates.

Preferably clusters of related maps are displayed to the user so as to indicate the closeness of the relationships using a menu or other user interface element or in a graphical presentation.

Preferably the main user interactions with individual debate maps, clusters of related maps and the debate repository as a whole can be performed using a an interface control that resembles a hand-held remote control with a message screen that can be dragged to a convenient location on the screen.

Preferably the user may conduct keyword-based searches to populate a menu of maps and map elements and view short previews of the content of such maps or map elements on a display screen.

Preferably visibly rendered channels may be used to navigate around contextual views by viewing preview information that indicates the target element at the head of each channel and by clicking any such channel to traverse to the said target element.

Preferably the user may, by scrolling over a succession of adjacent channels, readily view the ancestral path of any element.

Preferably protagonists in a debate may be represented in a debate map, and all arguments, positions or other debate elements may be visibly rendered or highlighted as associated with said protagonists.

Preferably users editing a specific map may create a new map made up of some part of the existing map.

Preferably users navigating around a large debate or repository of debate are, at all times, presented with a cognitively and technically tractable amount of map data.

Preferably users may search a debate or debate repository using criteria that include the semantic debate element type.

In yet a further broad form of the invention there is provided an interconnection system operable between a first computer on a network and at least a second computer on the network; said network including at least one database server; said system implementing the above described system whereby elements accessible on said first computer are linked to elements accessible on said at least a second computer.

### BRIEF DESCRIPTION OF DRAWINGS

| FIG. | Description |
|---|---|
| 1 | Layout of the web interface for viewing and editing maps. Shows |
| | the three main areas of the screen. |
| 2 | Example of a details view, showing the main groups of information |
| | displayed in such a view. |
| 3 | Example of an immediate context view. |
| 3a | Details view showing relationships between an element and |
| | a group of sibling children and a vertical channel |
| 4 | Example of an expanded context view. |
| 5 | Example of a down argument, or descendant subtree, view. |
| 6 | Example of an up argument, or ancestral, view. |
| 7 | Layout of the Debate Dashboard. |
| 8 | Flowchart of process to render a planar view |
| 9 | Layout of the Debate Dispatch Box |
| 10 | Flowchart of process to add a cross-relation |
| 11 | Menu to add a cross-relation |
| 12 | Flowchart of process to render a depth-wise view |
| 13 | Flowchart of process to navigate through the debate space using |
| | cross-relations |
| 14 | Example of a depth-wise view showing highlighted outline |
| | treeview |
| 14a | Details view of a horizontal channel |
| 15 | Example of sub-menu showing the users navigation steps, |
| | or session history |
| 16 | Dragging a new element by dragging from the element-type key |
| 17 | Edit menu showing allowed element types that may be added |
| | to the selected element |
| 18 | Moving an element and its subtree |
| 19 | Entering metadata for an articulation |
| 20 | Screen display following successful transmission and entering |
| | in the database of editing changes |
| 21 | The Debate Previewer |
| 22 | Schematic view of cross-relations |
| 23 | Schematic view of debate repository |
| 24 | Use of channels (guide columns) for navigation |
| 25 | Database diagram of possible relational database for the invention |
| 26 | Diagram showing location of and allocation of tasks between |
| | client computers, web server and database server. |

### DETAILED DESCRIPTION OF PREFERRED EMBODIMENT

The present invention extends and develops the disclosure of international patent application PCT/AU2005/000483 the description and drawings of which are incorporated herein by cross-reference. Each section in this description briefly recapitulates relevant features of the earlier invention and then describes the new, extended or improved feature in the present application.

### 1. Flexible Viewing Options

PCT/AU2005/000483 discloses an invention in which a debate map consists of a number of elements, otherwise termed nodes, where each element is of a specified type with a defined semantic significance, and where elements must be combined into maps in accordance with a set of rules, such set being termed a map grammar. The web interface presents this as a color-coded outline treeview, together with detailed information about one specific element.

The present invention provides a multiplicity of detailed or contextual views logically related to one specific element in the outline view. The selected element is referred to as the focal point. In Australian Patent 2006905855 contextual views are referred to as zoom views, and the terms are used synonymously in the present disclosure.

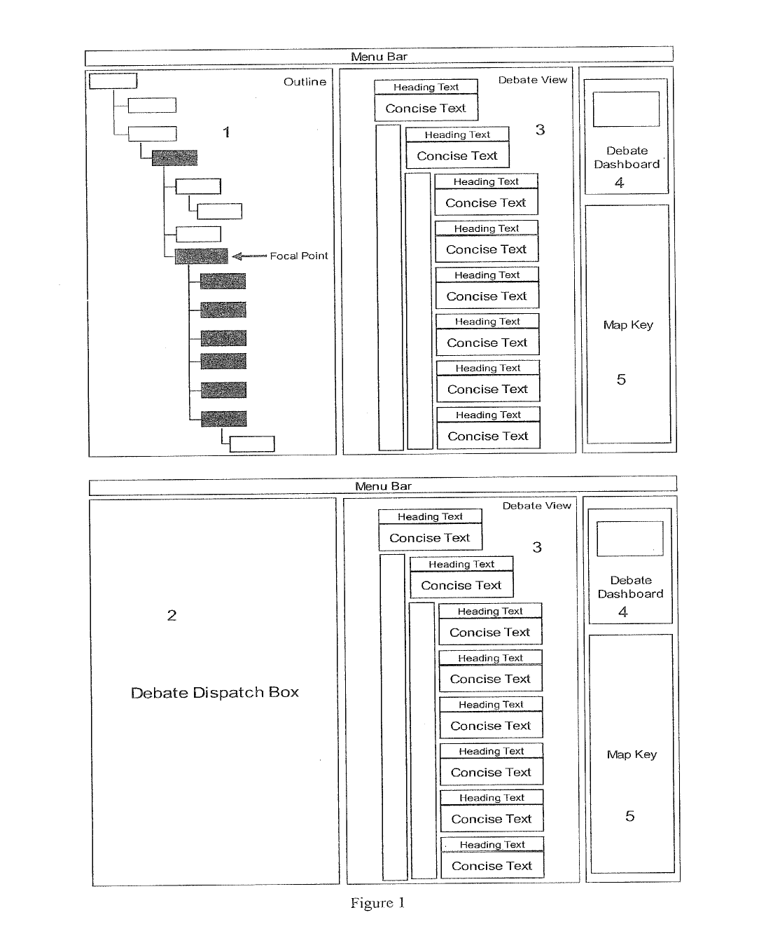

The main web page for viewing maps is depicted schematically in FIG. 1. The screen is divided into three areas. The left of the screen displays either an outline treeview 1 of the map or map portion currently being viewed, or a set of editing controls 2 referred to herein as the Debate Dispatch Box. The second area 3, which occupies the middle area of the screen, displays one of the five details or contextual views of a selected item or sub-area of the map. The third area occupies the right of the screen and displays a control cluster herein termed the Debate Dashboard 4, together with color-coded keys 5 representing the various element and cross-relation types available in the map.

In one embodiment, five such views are available to the user:

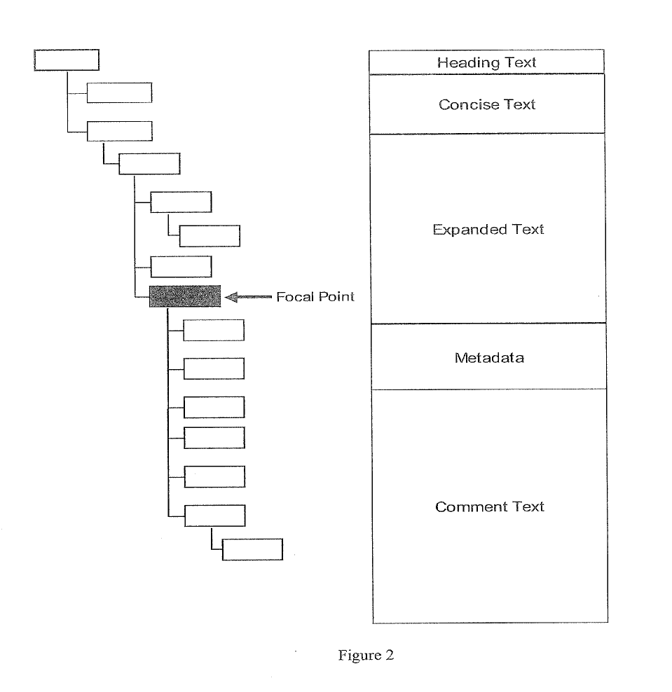

Details view (FIG. 2) displays the heading text (up to 70 characters), the concise text (up to 250 characters) and the expanded text (up to 50,000 characters) of the selected element, along with a set of metadata about the element and any free-comments that have been added by users. The details view may contain links which, when clicked, cause the display of one or more articulations of the debate element by debate protagonists, or of the editing history of the element. FIG. 2 shows an example of a details view, articulations and editing history, as rendered on the application web page.

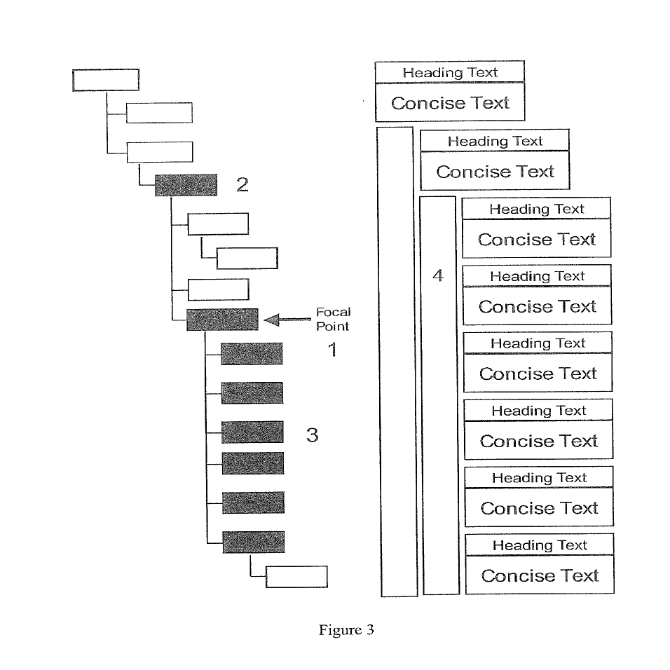

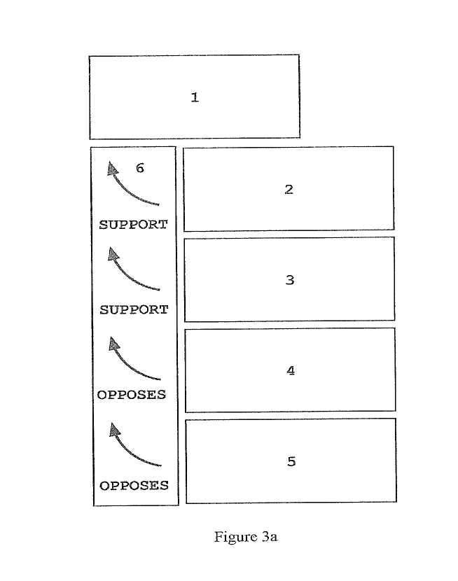

Immediate context (FIG. 3) displays the heading text and concise text of the element selected on the outline view, herein termed the focal point element 1, together with the same information about the parent 2 of the focal point element in the debate tree and the children 3 of the focal point element. Each element in any of the contextual views is color-coded to indicate element type, and may also include icons or other visual symbol indicating the presence of additional information such as an expanded text, incoming or outgoing cross-relations, articulations or comments. Item 4 of FIG. 3 shows a colored guide column into which all the relationships between elements flow upward toward a target element. FIG. 3a provides a detail view showing the relationship between parent element 1, child elements 2,3,4,5 and channel 6. Note that the channel contains arrows showing the direction of the relationship and a text indicating the nature of the relationship.

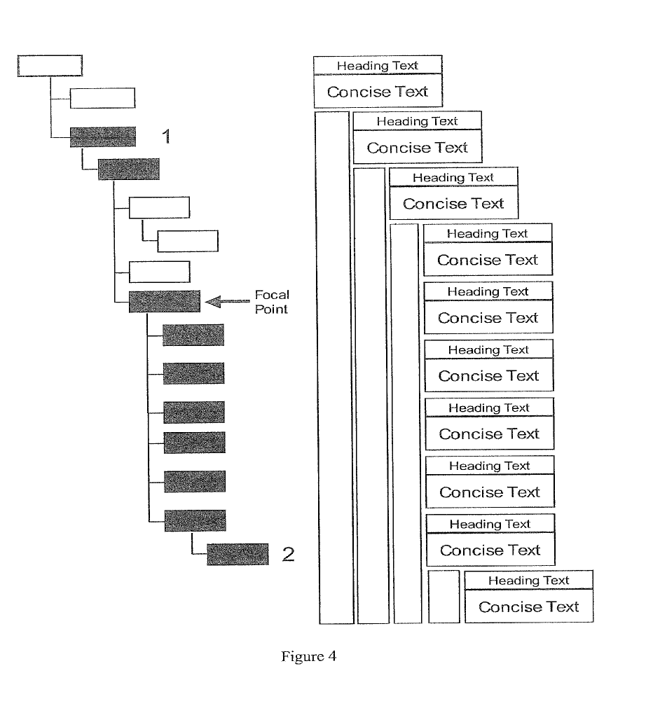

Expanded context (FIG. 4) shows the same information as the immediate context view, as well as the grandparent 1 and grandchildren 2.

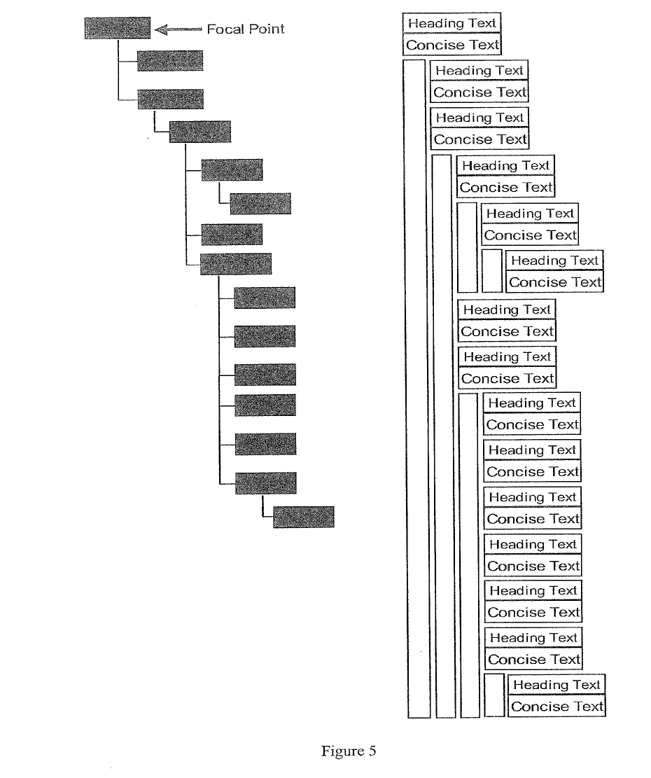

Down argument (FIG. 5) shows the heading and concise text of the focal point element and of all its descendants in the debate tree.

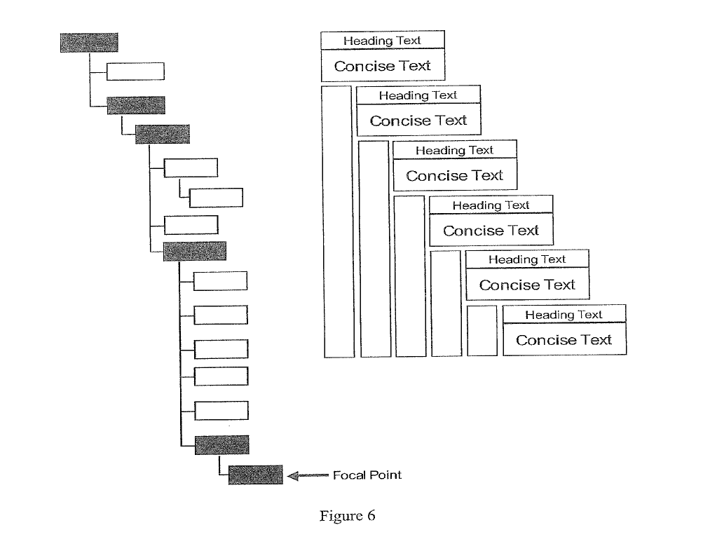

Up argument (FIG. 6) displays the heading and concise text of the focal point element and of all its ancestors in the debate tree.

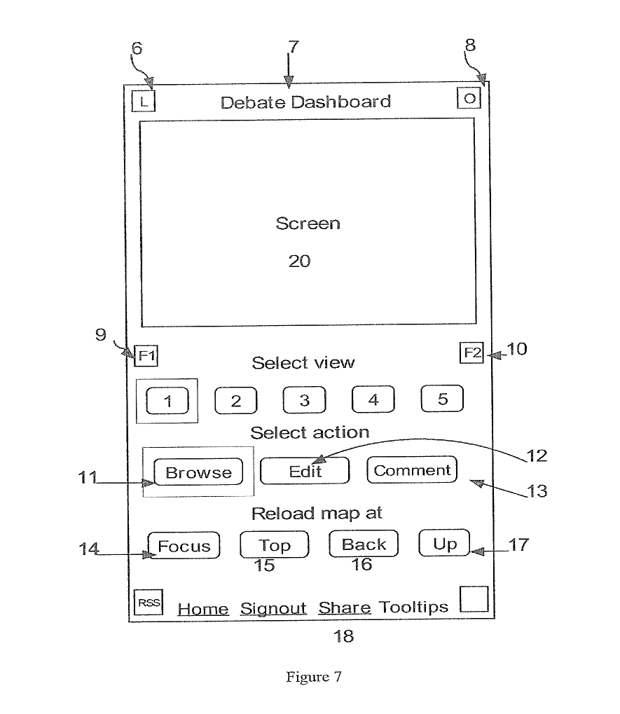

The user selects the desired view by clicking one of buttons labeled 1 to 5 on a cluster of interface display and controls herein referred to as the Debate Dashboard (FIG. 7). Alternatively, the user may select the same views by right-clicking an element on the outline view, or on a details or contextual view, causing a context menu to be displayed containing items for each view option.

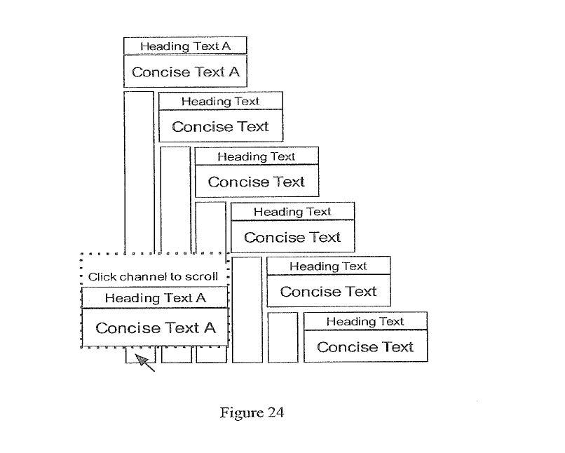

In each contextual, or non-details, view the argument elements are joined by channels (item 4 in FIG. 3) that connect a group of sibling child elements—that is, elements with the same parent—with the parent. To the left of each element box, and within the borders of a channel, a color-coded text and arrow indicating the relationship of the element to the parent element is visible. When a large map sub-tree is rendered, channels may be used for navigation. As the user moves the mouse over a channel, the heading and concise text of the channel is displayed surrounded by a dotted border. Clicking a channel causes the channel target—the element at the top of the channel—to scroll into view (FIG. 24).

When a contextual view is being displayed, all the elements in the contextual view are highlighted on the outline treeview, as shown in FIGS. 3, 4, 5 and 6. The visual correspondence and interrelationships between the outline and contextual view aids comprehension by enabling the simultaneous appreciation of context and focus. When a details view is displayed, only the focal point element (item 1 of FIG. 2) is highlighted on the outline treeview.

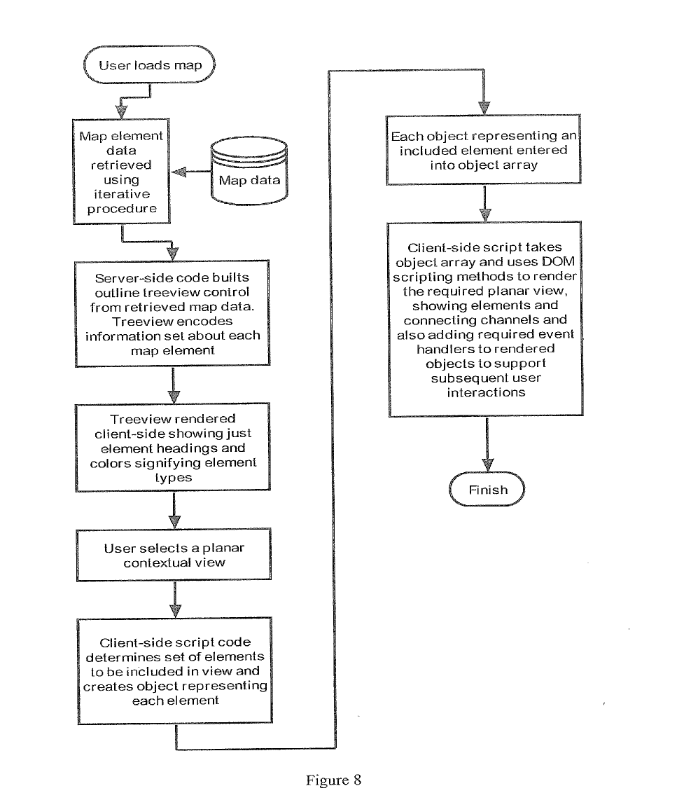

The planar view mechanism is implemented as follows (see flowchart in FIG. 8):
1. When the map-viewing page is first loaded, the outline treeview is generated and populated with color-coded items each displaying the heading text of an element. The tree hierarchy of elements is retrieved from the relevant database table using a stored procedure that executes an iterative method to retrieve the data to the required tree depth. Tree-hierarchic data is stored in a single table using what is standardly termed the ‘adjacency list’ method in which each element stores the unique identifier of its parent in the tree hierarchy. In this embodiment, server-side code executes to add each element to an ASP.NET treeview control such as that included in Microsoft's ASP.NET control suite, or other suitable treeview control such as that supplied by Telerik Inc.
2. As well as setting the visible elements for each element of the treeview, the additional information items are also stored as invisible attributes of the treeview control and transmitted to the client. This includes the concise text for each element, and additional data such as the type of the element, the number of articulations, comments and cross-relations.
3. When a details view is to be displayed, an AJAX callback is raised requesting the appropriately formatted information from the server. This may include comments and metadata about the element, as well as any expanded text. When the callback returns, client side script code executes that causes it to be displayed to the user.
4. When one of the contextual views is displayed, client-side script in JavaScript or other suitable languages executes and uses standard Document Object Model (DOM) and Cascading Style Sheet (CSS) to generate the required page code to generate the views displayed in FIGS. 3 to 6.
5. The behaviors exhibited when the user interacts with any of the views are also implemented using standard scripting and CSS techniques, which are commonly referred to as Dynamic HTML (DHTML).

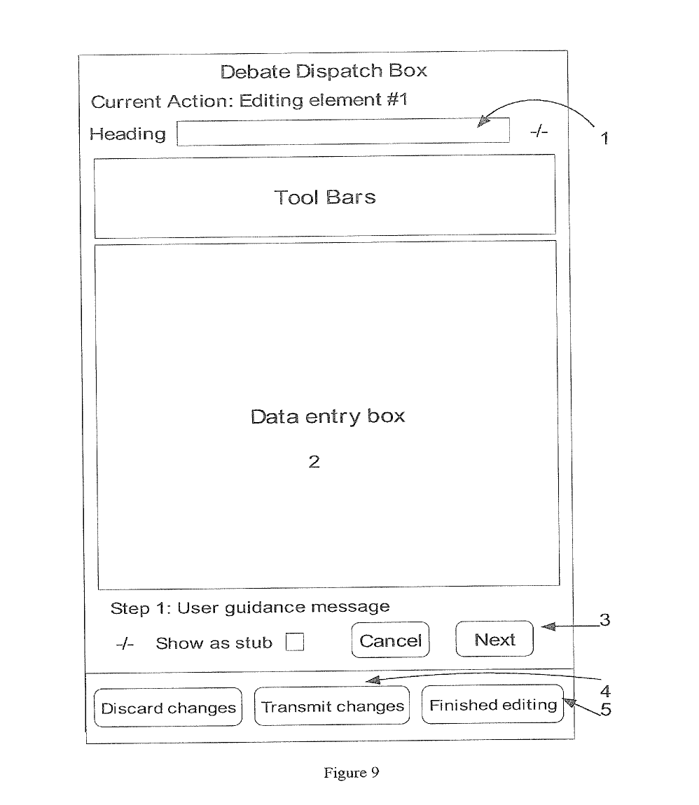

In one embodiment, any of the above views may be saved and shared using the following method:
1. The user selects the view and focus required, as described above
2. The user clicks the Share link (item 18 of FIG. 7) on the Debate Dashboard, or alternatively selects a sharing option from the Community menu at the top of the display. The latter option provides a choice of the rendered size of the saved debate view.
3. The Debate Dispatch Box is now made visible (FIG. 9), and the user may enter a heading and description of the view to be saved in areas 1 and 2 respectively.
4. When the user clicks the button 3 of FIG. 9, script code is executed that generates a string encoding the HTML for the saved view, along with any heading and description in text entry areas 1 and 2. This is forwarded to the web server by AJAX callback, and saved in a file on the web server.
5. When the callback returns from the server to the client, a message is displayed on the message area (item 20 of FIG. 7) of the Debate Dashboard that includes a link to the saved view. When the user clicks this, the view is displayed in a separate window.
6. The rendered view includes two text boxes that contain a simple link to the view and code for an HTML 1Frame (or similar embeddable object) element that enables the view to be embedded in blogs or web pages.

The above feature is implemented using client-side scripting, together with server coding to save the views to the server filing system.

### 2. View Filtering

PCT/AU2005/000483 describes a method for filtering information displayed in map views by excluding stipulated element types or by excluding elements assessed by the user community as below a specified average level of significance. Such filtering is handled on the server.

The present invention supplements this with a client-side filtering mechanism. The above-mentioned Debate Dashboard (FIG. 7) includes two buttons labeled F1 (item 9) and F2 (item 10). In this embodiment these buttons provide client-side filtering functionality as follows:

F1 excludes from a contextual view certain element types considered to be of subsidiary status in the overall map structure. In one implementation, the excluded types are subsidiary issues, defined as issues that are not direct children of the root, or map, element of the map that defines the broad subject matter of the map. Also excluded are components of positions, a position being a multi-part proposal or policy posited in response to an issue raised within the map.

F2 excludes elements that have been assessed by the map community as being below some stipulated level of significance. The cutoff value may be modified by users using the Filter setting of the top menu. The mechanism for assessing significance may be implemented by a menu or alternatively by users keying in a relevant integer value while a particular element is selected.

Both of the above mechanisms are implemented using client-side scripting in which the elements to be displayed in a contextual view are maintained as a client side array, the contents of which are modified by the aforementioned filtering actions.

3. Cross-Relations within and Between Maps

In the invention described in PCT/AU2005/000483, maps have a tree-hierarchic data structure in accordance with recognized methods for argument or debate mapping.

In the present invention, this is supplemented by the ability to create semantically meaningful cross-relations between pairs of elements, where such elements may be in the same map, or different maps. In graph-theoretic terms, a cross-relation is a directed edge, consisting of a pair of elements with a directed relationship between them. Each cross-relation must be one of a plurality of allowed types specified in the database that forms part of the system. The formation of cross-relations is constrained by rules, also encoded in database tables. Such rules ensure that only semantically intelligible relations are made. The set of possible cross-relation types, and the set of constraining rules, form an extension of what is referred to as a ‘map grammar’ in PCT/AU2005/000483. In the previous invention, such rules set out an ontology of element types, and rules constraining how they may be combined in argument trees. The new invention adds to this an ontology of cross-relation types and rules governing the element types that may be joined using such relations.

The embodiment described here includes the following cross-relation types. These are displayed at the bottom of the information key that appears at the right of the display screen. Other cross-relation types can be added by making appropriate entries in the database ontology and rule tables:
1. Equivalence relations assert substantive equivalence between two elements in a reflexive, or two-way, relationship. This can be used to assert that, for example, two arguments, or two positions taken in a debate a substantively the same even though they may occur in different debate contexts and/or are expressed in different words. It also provides one of two methods disclosed here to model what is standardly termed divergent debate structure (see below).
2. Grounding relations can be used to assert that one element, typically a position, in some sense grounds another. One application would be to represent a warrant-type relationship as described by Steven Toulmin (Stephen E. Toulmin, The Users of Argument, Updated Edition, Cambridge 2003). More generally, a general principle espoused in one map may ground a specific invocation of the principle in another map, or the same map.
3. Variation relations can be used to assert that one element is a variation of another. For example, a position may be a variation of another.
4. Advocacy relations can be used to assert that a protagonist—a debate participant—advocates the target position. This embodiment of the invention includes a Protagonist element type in the debate ontology.
5. Relevance relations simply assert the relatively week relation that one element is relevant to another in some sense.

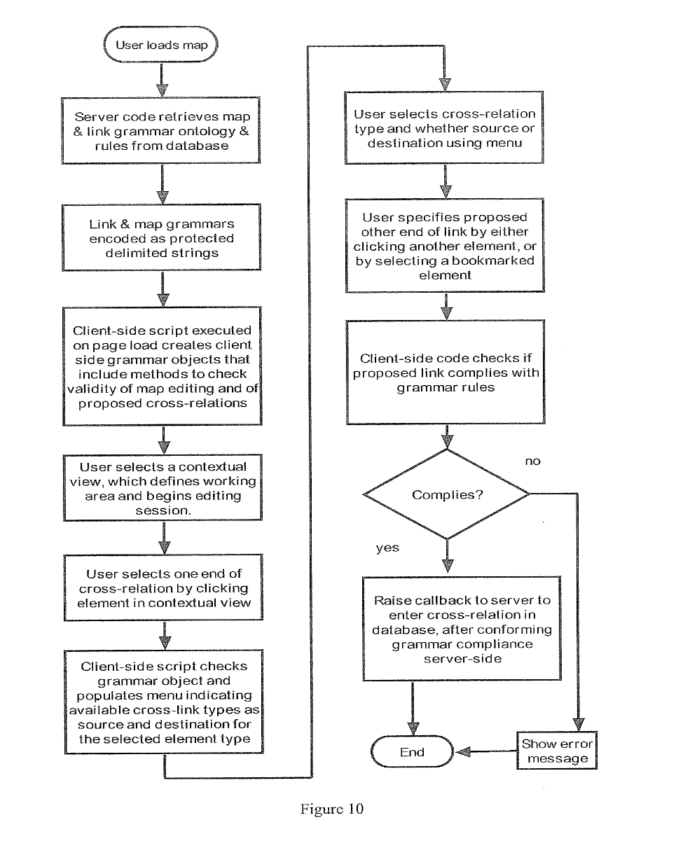

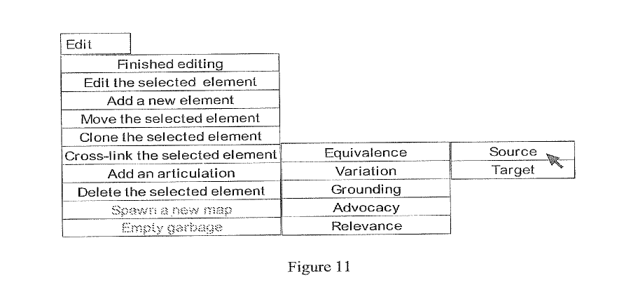

In one embodiment of the invention each of the above relationship types may be added by users with editing permission as follows (see flowchart in FIG. 10):
1. The user displays a contextual view such as those depicted in FIGS. 3 through 6 that includes one, or preferably both elements between which a cross-relation is to be asserted. The user clicks an element in the contextual view.
2. The moves the mouse over the top Edit menu, causing it to open, and then moves the mouse to over the menu item to add a cross-relation, which causes a further sub-menu to open showing the available cross-relation types, with another sub-menu displaying the option to make the selected element the source or destination of the relation. Options not allowed by the cross-relation rules are grayed-out (FIG. 11)
3. After selecting the menu item in step 2, the user is prompted to select the other end of the relation by either clicking another element in the current contextual view, or selecting a bookmarked element in the same map or another map on the bookmarks menu.
4. Programming code then queries a client-side object that is created when the page is first loaded that encodes all the relevant rules concerning the formation of cross-relations. If the cross-relation is permitted by these rules, the cross-relation is formed.

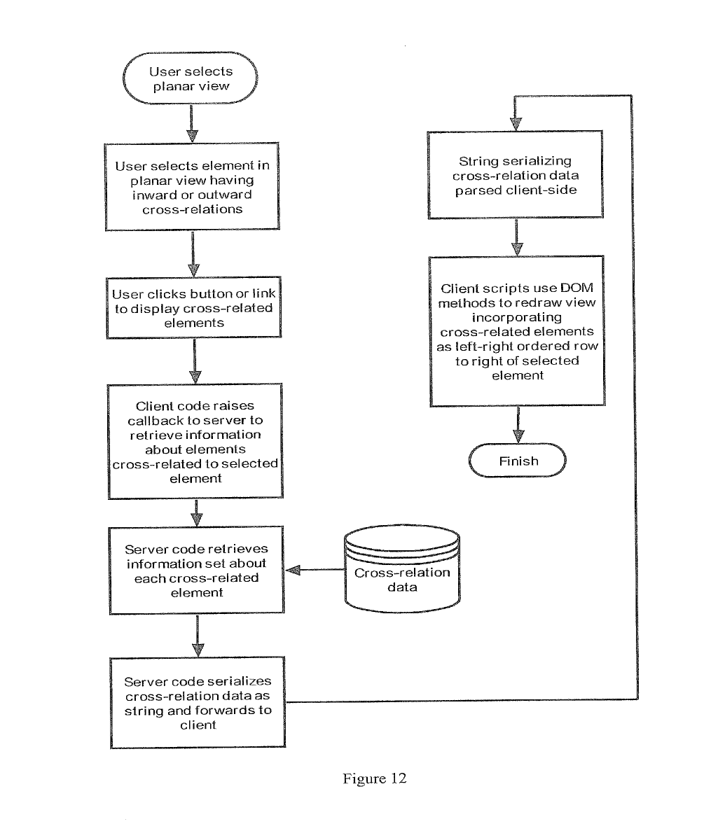

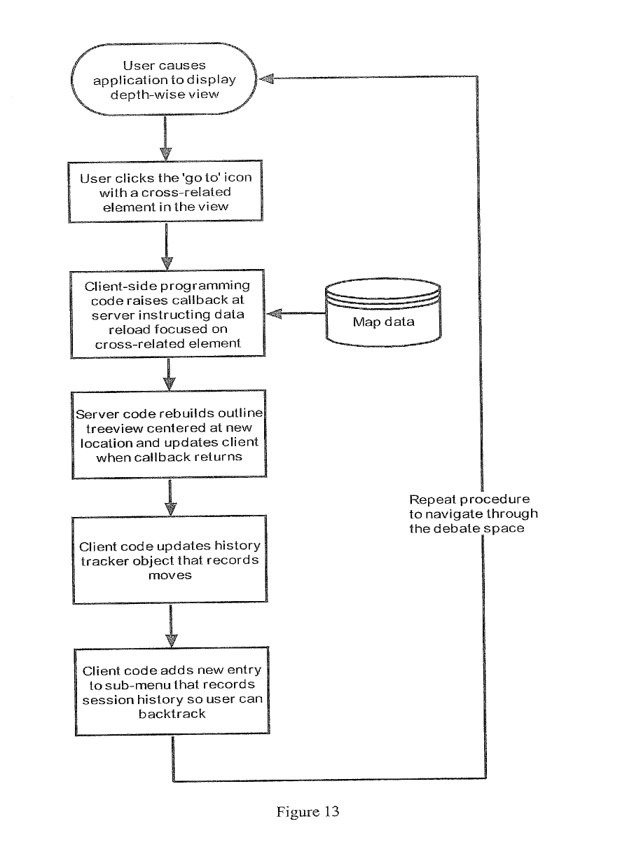

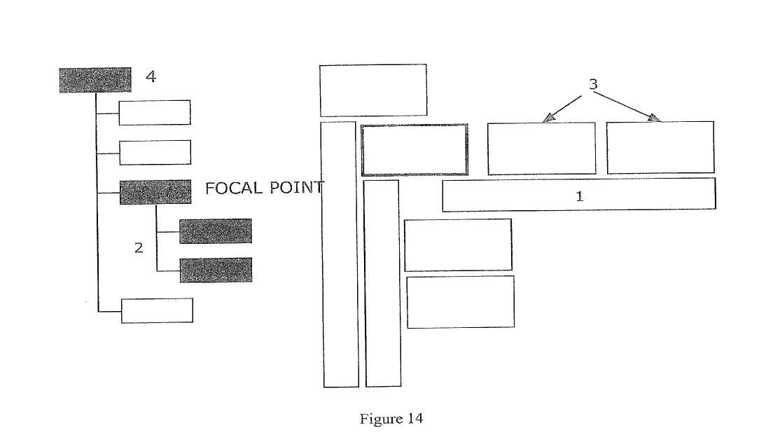

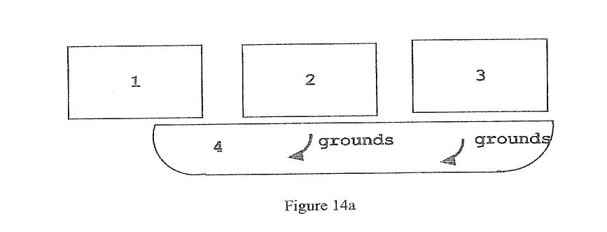

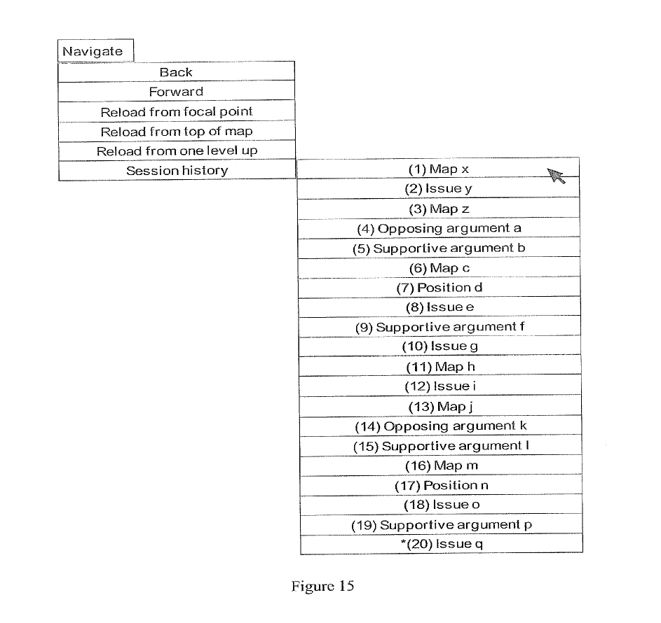

Cross-relations can be used to navigate around the application. In the embodiment described here, this works as follows (see flowcharts in FIGS. 12 and 13):
1. When any of the contextual views are being displayed, each element on the view may have an icon or other visible cue indicating that there are incoming or outgoing cross-relations. When the user moves the mouse over either icon, a tooltip appears giving the number of incoming or outgoing cross-relations.
2. Clicking on a symbol signifying the presence of incoming or outgoing cross-relations causes information about the elements either within or outside the current map to be retrieved and displayed to the right of the selected element, as shown in FIG. 14. The related elements are arrayed in a specified order from left to right, with the most significant elements displayed in the left-most position, the least in the right-most position.
3. In one embodiment, users of the application may evaluate the strength or significance of any cross-relation, and the average such evaluation is used to determine the left-right ordering. In another embodiment, the ordering can be determined by the size of the subtree of the related element; that is, the number of descendant elements could be taken as a proxy for the level of activity or interest in the related element.
4. The set of related elements 3 of a given element are jointed by a horizontal channel (item 1 of FIG. 14), which performs a role analogous to the vertical channels that connect sibling elements in a planar view. FIG. 14a provides an expanded view of the horizontal channel of FIG. 14. In this example, elements 2 and 3 provide a grounding principle for element 1. The grounding relationship flows via the horizontal channel 4, which contains arrows indicating the direction of the relationship and text describing the relationship semantics—in this case elements 2 and 3 ground element 1.
5. When the cross-related elements are displayed, the outline treeview 2 is modified to highlight any cross-related elements that are contained on the current treeview, as shown by item 4 of FIG. 14. Cross-related elements in other maps cannot be highlighted in this way.
6. In this embodiment, protagonists to a debate are represented in the debate map as Protagonist elements. Protagonist elements may have a cross-relationship of type Advocacy with elements that represent positions, claims or component parts of these. The cross-relation mechanism described above may be used to highlight all of the elements of a debate advocated by a given protagonist.
7. Each related element displayed in a cross-relation view contains an icon or link which, when clicked, transfers the user to the element in its native context, which may be in the same or a different map. When viewed in its native context, the related element will be shown having a relation that is the obverse of that of the original element. For example, if an element is related to another element by an outgoing relationship, then the related element will have a corresponding incoming relationship.
8. This provides a method of navigating through an entire repository of debate in which the user first discovers the elements related—in different ways—to a given element, can jump to any one of the related elements in their native context, and can then view and follow any relations of the new element. This can be repeated, creating a path through the debate repository. For example, suppose that a position or argument that appears in one map is grounded by a general principle that is enunciated and debated in another. A user in the first map may use the above method to jump to the debate surrounding the general principle in its original map, or native, context and from their see what other elements in other maps are grounded by the same principle.
9. Whenever the user navigates through a debate repository using the above method, and also when a user navigates by jumping to a bookmarked location, or when a map is first loaded, program code executes to check the total number of elements in the map or map portion being loaded. If the number of elements is greater than can reasonably be handled at once by either the server or client computer, the number of elements loaded is limited to a maximum number, with any element having an un-retrieved descendant subtree being visually distinguished by an icon or other symbol or text. To view this unretrieved subtree, the user may select the element and by clicking button 14 of FIG. 7 on the Debate Dashboard, load a fresh set of map data starting at the selected element. This procedure can be repeated, enabling the user to work with very large maps and repository while working with a manageable dataset of map data at any one time.
10. Each of the above navigational steps is recorded and can be retraced. Such recording may be handled on the client or server computer. Users may back-track using a back button on the Debate Dashboard (item 16 of FIG. 7) or by using a session history displaying each step, which could be displayed using a menu (FIG. 15).

The cross-relation feature and the associated navigation functionality are implemented in this embodiment as follows (See flowcharts in FIGS. 10, 12, 13):
1. Information about cross-relations, cross-relation types and rules governing the creation of such relations are stored in a set of related database tables. These tables provide an additional web of relations to those specified by parent-child relations in the tree-hierarchic debate map structure. In graph-theoretic terms, a multigraph is overlayed on top of a multitree making possible the representation and navigation of very complex debate structures.
2. The addition of new cross relations is achieved through a combination of client-side scripting and server code and executable stored procedures within the database.
3. Rules constraining cross-relations are encoded in a client side object with functions that can be used to check the legality of a proposed cross-relation.
4. Following validation, information about new cross-relations is serialized as a string and forwarded to the server by AJAX callback.
5. At the server, the information is de-serialized and passed to the database, where the appropriate table entries are made by programming code contained in a database stored procedure to record the change. This includes updating columns for the relevant elements, stored in a separate table, indicating number of incoming and outgoing information for each element.
6. When a map, or part thereof, is displayed to the user, counters of the number of cross-relations for each element are retrieved and stored in the outline treeview when such treeview is programmatically built at the server. When the treeview is loaded on the client, this information is rendered by client-side script programming as visible icons or links on elements displayed in contextual views. The same information could also be displayed on the outline view.
7. Client-side scripting is used to handle clicks on such icons, and to call routines that retrieve information about incoming and/or outgoing cross-relations for any given element from the server using AJAX callbacks. When such information is received client-side, script programming employing standard Dynamical HTML methods renders each cross-related element in the form described above.
8. When the user clicks the link in a rendered cross-related element, client-side logic raises a callback that causes a server-side method to be called which re-populates the outline treeview with information focused on the element but in the element's native context. This information is forwarded back to the user, and the relevant contextual view in the new context is rendered.
9. Information about each such jump is stored in a client-side object that keeps track of such actions, and a menu is populated enabling the user to backtrack or to jump to any particular location in the session history.

### 4. Asynchronous Editing System

This disclosure includes an improved system for editing elements within maps and associated information that takes advantage of Asynchronous JavaScript and XML (AJAX). The new method enables users with editing permission to build substantial hierarchical map subtrees and other constructs client-side before forwarding them to the server.

The interface for editing maps is displayed in FIG. 9. Note that the editing panel, described herein as the Debate Dispatch Box, occupies the same space on the display surface as the outline treeview. The editor is made visible as required by manipulating relative CSS z-index values.

In editing map structures, the user first begins an editing session by clicking the Edit button (item 12 of FIG. 7) after first selecting a contextual view and focus element. This rendered contextual view defines the working area for the editing session. The user can select any existing element for editing by clicking it, which causes the heading and concise text entry areas on the Debate Dispatch Box to be re-populated with values for the selected element. After editing the heading and concise text, the user clicks next, at which point the expanded text for the element, if any, is loaded. The expanded text may be a long article with embedded images, animations or other media items. After editing the expanded text, the user clicks the Finish button. Another editing operation can now be selected.

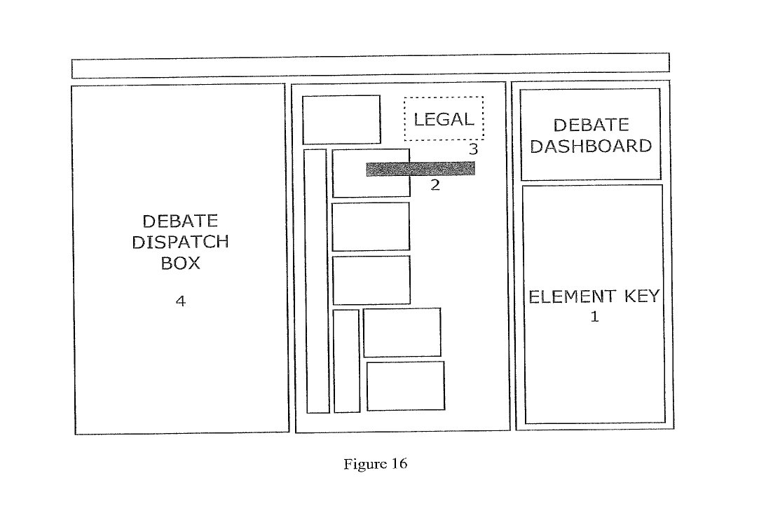

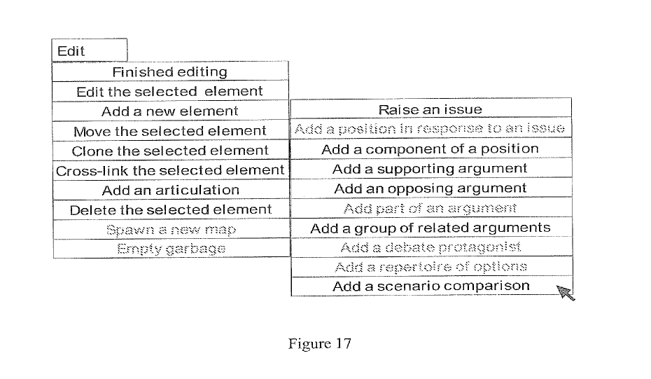

Users may add new elements using either of the following methods:
1. Clicking an item on the color-coded key 1 of element types (FIG. 16) and then moving the mouse on to the contextual view. As this is done, a colored rectangle 2 representing the new element follows the mouse cursor. As the mouse is moved over different elements in the contextual view, messages 3 are displayed indicating if to add the proposed new element to the element that the mouse is over is a legal move or not under the set of rules specified by the applicable map grammar, which stipulate the allowed child element types of each element type. When the mouse cursor is over the desired parent, the user clicks again and the new element is added. The user then enters the heading and compact text on the Debate Dispatch Box, clicks Next, and then optionally adds an expanded text to complete the operation.
2. By using the Edit menu visible at the top of the display. By moving the mouse over the Add new element item, the user can view the allowed child items of the currently selected item. Element types that are not allowed under the map grammar are shown grayed-out (FIG. 17).

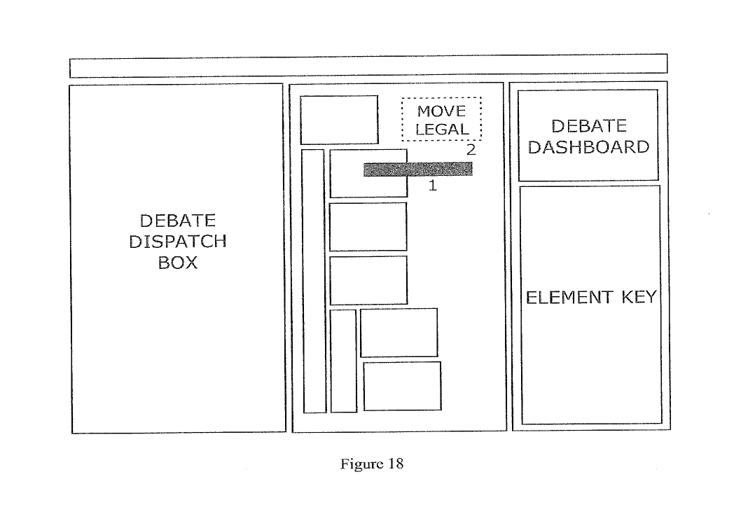

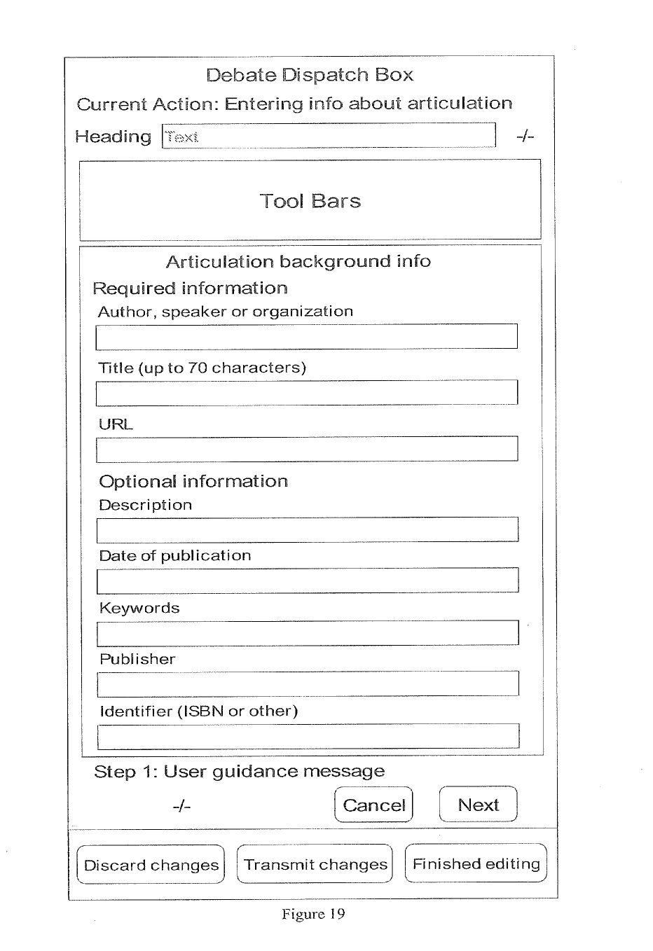

Users may also move and copy map elements from one location to another, as follows:
1. To move or copy an element, the user first selects a contextual view that preferably contains both the element to be moved and its destination—that is, the element that is to be its new parent.
2. The user then begins an editing session, if one has not already begun, by clicking the Edit button.
3. The user selects the Edit menu item to move or copy an element. Once this is done, the mouse cursor is followed by a rectangle 1 containing the heading of the to-be-moved element (FIG. 18).
4. As the user moves the mouse cursor, followed by the above-mentioned rectangle, over different elements in the current contextual view, tooltips 2 appear indicating whether moving to each element is a legal move or not according to the rules of the map grammar.
5. When the user has found a suitable destination, the mouse is clicked again. In the case of a move element action, the element and its subtree are moved to the new location. In the case of a copy element operation, a copy of the copied element appears.

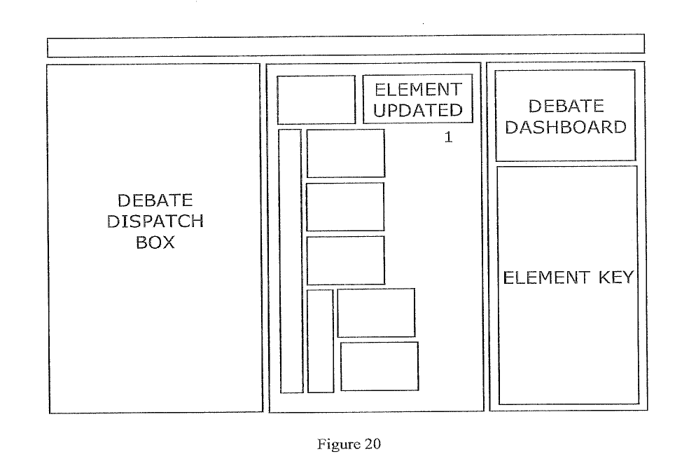

Users may also add articulations by selecting the Add an articulation item on the Edit menu. Articulations are expressions of the argumentative element by actual participants, or protagonists, in the debate drawn from newspaper articles, speeches or other sources. They may be textual, or may be expressed using audio-visual or other media. The Debate Dispatch Box is exposed, and the user is prompted to enter a standard set of metadata about the articulation, including a URL (FIG. 19). When the user clicks the Next button, the large text entry box is cleared and the user is able to enter an excerpt from the articulation.

Users may also change an element's type as follows:
1. In an editing session, the user selects the element which is to have its type changed.
2. Application code determines which element types are permitted by the relevant map grammar in the position of the element to be changed.
3. A menu is displayed of legal element types in this position.
4. The user selects one of the legal types.
5. Application code executes recording the selection and forwarding such selection to the server where the requisite database change is made.

In this embodiment, it is also possible for users editing a particular debate map to spawn a new map from an issue, or other element, which is thought to warrant being handled by its own map. The procedure to do this is as follows:
1. In an editing session, the user selects the issue or other element that is to form the basis of the new map.
2. The user selects the Spawn new map item from the editing menu.
3. Programming code determines the unique identifier of the element that is to form the basis of the new map.
4. Programming code raises a callback which is transmitted to the server.
5. Server-side code calls database methods that create a new map, with a new root element.
6. Database code transfers the element and its subtree to the new map by re-setting the unique identifier of the parent of said element.
7. Database code creates a placeholder element where the transferred element was in the original map.

The user may continue editing existing elements or adding new elements until ready to forward the changes to the server for insertion in the debate database. This is accomplished by clicking the Transmit changes button. If the changes are entered successfully, confirmatory flags are displayed alongside each new or changed element (FIG. 20). If errors occur, error messages are displayed.

The above editing system is implemented as follows:
1. Editing changes and new elements are entered, with formatting and image and link insertion made possible by using a standard online editing product such as the Telerik r.a.d. Editor component.
2. All editing changes made in the course of an editing session are stored client-side in a client-side object. Original values of element texts are saved along with new values to facilitate concurrency checking at the server. This is done using programming code written in an appropriate scripting language such as JavaScript. Text entry is validated to ensure compliance with maximum length restrictions and other requirements.
3. When the user clicks the Transmit button, programming code reads all the new and old values for each element from the client-side object and serializes them into a delimited string. This is transmitted back to the server using an AJAX callback.
4. At the server, the string is checked to exclude malicious scripts or other inputs and forwarded to the database server.
5. At the database server, which may be Microsoft SQL Server or other comparable product, the string is parsed using a database stored procedure to extract all of the individual editing changes. These may include new elements, editing of existing elements, deletions, element moves to new locations, or the addition of articulations. These changes are stored in a table variable for subsequent processing.
6. Stored procedure logic then loops through all the changes stored in the table variable, processing each change appropriately depending on the type of editing action.
7. In the case of editing actions, concurrency checks are performed to ensure that the text has not been changed by another user since the user downloaded it. If it is, the change is not made and an error code is entered in a string to be returned to the client and the user is presented with options as to how to proceed, including reviewing the editing history of the element in question before re-sumbitting any changes.
8. In the case of element additions, each new element is assigned a temporary identifier client-side to distinguish it from other new elements. When the new element is inserted in the database, the database server assigns a primary key value which is the unique identifier of the element within the table of elements. To ensure that any new child elements added to such a new element are assigned the correct parent identifier, another table variable is populated that matches the temporary values assigned client-side with the permanent values assigned by the database. In this way, as each subsequent new element is added in a subtree, the temporary parent identifier can be replaced with the permanent parent identifier.
9. At the conclusion of the looping process that handles each editing change, a report on each operation, whether successful or not, is encoded in a string to be returned to the client via the web server.
10. When the above-mentioned string-encoded report is received at the client, such string is parsed to extract the reports on each individual editing operation attempted. JavaScript code is then executed to display the relevant result alongside each edited element on the contextual view.
11. The user terminates the editing session by clicking the Browse button. Normal browsing may now resume. Alternatively, the user may select another focus and contextual view and begin editing another part of the map.

### 5. Draggable Debate Dashboard

The invention disclosed here features a significantly changed web interface compared to that described in PCT/AU2005/000483. One aspect of this is the introduction of an interface component referred to herein as the Debate Dashboard as the focus for most user interactions with the application. The Debate Dashboard bears some similarity to a hand-held remote control device with a message area for displaying context-sensitive feedback and help information to the user, and can be detached and dragged around the screen to be repositioned for convenience.

The Debate Dashboard (FIG. 7) contains the following components:
1. A small message area 20 that displays dynamically generated hints, error and feedback messages to the user.
2. A row of five buttons (1 to 5 of FIG. 7) that allow the user to select either a detailed view of the selected element (view 1) or different contextual views (views 4 to 5). These views are described above.
3. A row of buttons that allow the user to switch easily between browsing a map, editing it, or commenting on it (items 11, 12, 13 of FIG. 7).
4. A row of buttons (item 14 to 17 of FIG. 7) that allow the user to reload map data from the focus element, from the map root, to the previous re-positioning (if any) and one level up the map's ancestral tree (if not already positioned at the root).
5. A row of links 18 that allow the users to subscribe to an RSS or Atom feed, save and share the currently displayed view, or to sign out or return to the home page without signing out.
6. Four buttons (items 6, 8, 9, 10 FIG. 7) having a toggling action that allow the user to switch between a portrait or landscape rendition of the current contextual view, to display the contents of the message display area in a separate window, or to apply the F1 and/or F2 filters of map content.

The dashboard can be detached from its normal docking position by clicking its heading with the mouse, moving the mouse to the desired location and clicking again to fix it in a new position. The dashboard may be returned to its normal position by again clicking the header and dragging it to the right. As the dashboard is moved passed the right edge of the view display area, it automatically snaps back into its docking location.

The Debate Dashboard is implemented using standard Dynamic HTML methods.

### 6. The Debate Previewer

The embodiment disclosed here includes an interface feature that allows users to preview debate maps, or elements within debate maps, before loading the map itself. This feature is termed herein the Debate Previewer.

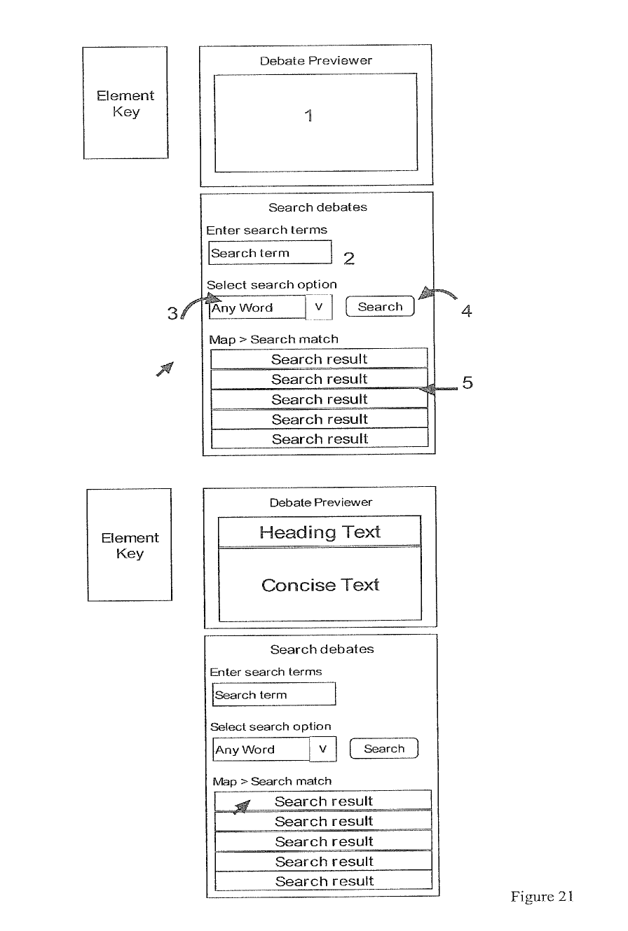

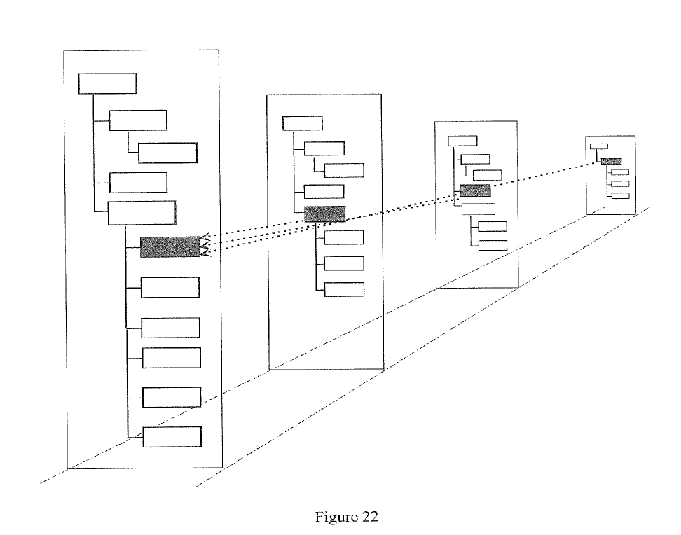

The Debate Previewer is a cluster of page controls consisting of the following (FIG. 21):
1. An area 1 where previews of maps or elements are displayed.
2. A box 2 where search terms may be entered.
3. A drop-down list 3 allowing the user to select a search option—any word, all words or exact phrase.
4. A button 4 to begin a search.
5. A menu to display search results. The menu consists of a list of maps containing matches, with each map having a sub-menu showing the individual elements that match.
6. A separate menu containing user bookmarks.

When the above menus are populated, moving the mouse over any of the menu or sub-menu items causes a preview to be displayed in the display area consisting of the heading and concise text of the element with color-coding appropriate to the element type. The user may load the map starting at either the map root or a particular search result by clicking the menu item.

The information necessary to show the previews is added to each menu item on the server by setting a custom attribute as provided by the Microsoft ASP.NET framework web controls. In one implementation, a proprietary menu control that provides such custom attributes may be used—for example, the Telerik r.a.d. menu. The display of the previews on mouse-over is handled by client-script reading the relevant custom attributes and formatting and displaying the information using standard Dynamic HTML methods. The embodiment described here also includes a facility to add to search criteria an element type, or set of element types so that, for example, only elements representing supportive arguments are retrieved. In one embodiment, this is included as a sub-menu to drop-down list 3 of FIG. 21.

1. A fully web-enabled software system, embodied in a non-transitory computer-readable medium, for building, editing, evaluating, rendering, navigating and storing an integrated repository of debate in which schematic representations of individual debates are bound together to form an over-arching repository of debate by a multiplicity of user-specified semantic cross-relationships that allow the emergence of clusters of related debates; said system comprising:
a. Application software that allows system users to build and edit debate maps made up of discrete elements representing entities such as issues or questions, claims, positions, and simple and compound arguments, scenarios and debate protagonists in accordance with a set of constraints herein termed a map grammar that ensure that such maps are constructed in accordance with sound argumentation principles, and in which the set of all such maps are stored in a single, unified data structure; and
b. Application software that enables users of the system to create an additional layer of semantic cross-relationships between individual debate elements, or nodes, where such elements may be in the same debate map, or in different debate maps, thereby making possible the representation of relationships between debates as well as relationships within elements of single debate maps.

2. The system as recited in claim 1 wherein each cross-relationship must be one of an allowed set of cross-relationship types in a set stipulated for the particular map, each with a defined semantic significance.

3. The system for creating semantic cross-relationships as recited in claim 1 wherein the formation of cross-relationships is constrained by a set of rules reflecting sound argumentation principles, herein termed a link grammar.

4. The system recited in claim 1 wherein the user may view an individual element in a particular map together with a group of other elements each defined by different logically defined contexts, herein termed planar views, within the debate map.

5. The system as recited in claim 4 wherein a detailed view of the individual element, including its heading, concise expression and long expression, metadata about the element, together with different articulations of the element by real-world debate participants and any free-form comments on it, is presented to the user.

6. The system as recited claim 4 whereby the element is viewed together its parent and immediate children in the debate map tree hierarchy.

7. The system as recited in claim 4 whereby the element viewed together with its parent and grandparent, and its children and grandchildren in the debate map tree-hierarchy.

8. The system as recited in claim 4 whereby the element is viewed together with its complete subtree in the debate map tree hierarchy.

9. The system as recited in claim 4 whereby the element is viewed together with its complete ancestral path, up to and including the root of the debate tree hierarchy.

10. The system as recited in claim 4 wherein any of the planar views may be combined with the display of cross-related elements in the same or other debate maps to provide multi-dimensional views, herein termed depth-wise views, that show both how an element is related to other elements in an individual debate map as well as with elements that may be cross-related in other ways and which may be in other maps and arbitrarily distance in the overall debate database.

11. The system as recited in claim 10 whereby the display of related elements in either a planar or depth-wise view may be ordered to reflect user evaluations of the significance of the elements displayed, or by other metrics including the size of the subtree attached to an element.

12. The system as recited in claim 1 whereby users of the system may build and edit individual maps, and create and evaluate cross-relations within and between maps.

13. The system as recited in claim 10 whereby any of the planar or depth-wise views include, for each element, an indication of the presence of any cross-related elements, whether incoming to the element or outgoing from the element, together with a means to load and display such elements into the view by clicking an icon or link or other method.

14. The system recited in claims 10 whereby the user, having displayed a depth-wise view focused on a particular element that includes cross-related elements as well as proximate elements in the debate tree, may navigate to any displayed cross-related element by loading a map view focused on said element in its own native map context, and from there in turn navigate to other elements related to any element in the newly displayed view, and by repeating these steps follow a path through the debate repository.

15. The system recited in claim 1 whereby application programming Maintains metrics of the number and strength of cross-relationships that cross map boundaries and applies such measures to generate clusters of related maps.

16. The system recited in claim 1 whereby the user is able to filter out parts of a debate map deemed to be of lesser significance.

17. The system recited in claim 16 including a method of filtering maps by excluding certain element types, such as subsidiary issues raised in the context of a map, or component parts of positions taken in debates.

18. The system recited in claim 1 whereby clusters of related maps are displayed to the user so as to indicate the closeness of the relationships using a menu or other user interface element or in a graphical presentation.

19. The system as recited in claim 1 whereby visibly rendered channels may be used to navigate around contextual views by viewing preview information that indicates the target element at the head of each channel and by clicking any such channel to traverse to the said target element.

20. The system as recited in claim 19 whereby the user may, by scrolling over a succession of adjacent channels, readily view the ancestral path of any element.
